(19) United States
(12) Patent Application Publication
(10) Pub. No.: US 2026/0326049 A1
(43) Pub. Date: Oct. 22, 2026

(54) FOOD PROCESSING SYSTEM AND METHODS

(71) Applicant: H.J. Heinz Company Brands LLC, Pittsburgh, PA (US)

(72) Inventors: Tom Pieter Hendrik Thielen, Wijchen (NL); Lucas João Mezzomo, Nijmegen (NL); Hans Mulder, Groesbeek (NL); Willy Rutten, Groesbeek (NL); Francesco Torraca, Nijmegen (NL); Vaishnavi Rudraraju, Irving, TX (US)

(21) Appl. No.: 19/110,490

(22) PCT Filed: Sep. 14, 2023
(86) PCT No.: PCT/US2023/032738

§ 371 Date: Mar. 11, 2025

Related U.S. Application Data
(60) Provisional application No. 63/407,499, filed on Sep. 16, 2022.

(51) Int. Cl. B01F 23/50; A23B 2/40; A23B 2/50; B01F 23/53; B01F 23/80; B01F 25/31; B01F 27/112; B01F 35/21; B01F 35/221; B01F 35/71; B01F 101/06

(52) U.S. Cl. CPC B01F 23/56; A23B 2/405; A23B 2/50; B01F 23/53; B01F 23/805; B01F 23/811; B01F 25/31; B01F 27/112; B01F 35/21111; B01F 35/22141; B01F 35/71731; B01F 35/7176; B01F 2101/06

(57) ABSTRACT

In one aspect, a food processing system is provided including a first flow line and a second flow line. The first flow line includes a mixer and a pump for pumping a fluid from the mixer. The second flow line has a first conduit extending from a hopper containing solid particles to a rotary feeder and a second conduit extending from the rotary feeder to the first flow line.

### RELATED APPLICATIONS

This application claims priority to U.S. provisional Application No. 63/407,499, filed on Sep. 16, 2022, which is hereby incorporated by reference in its entirety.

### FIELD

This disclosure relates to food processing systems and, more particularly, systems for dosing particles into a stream.

### BACKGROUND

Many food processing systems may include a processing flow path along which a food composition is transported for processing. For example, the food composition may be flowable food composition that is pumped from a mixing system via tubes, pipes, and the like, and through a sterilization system to sterilize the food composition before packaging.

In some food processing applications, the processed food composition includes rigid particles or solids in a fluid. Passing the rigid particles through a pump may cause damage to the pump over time, such as by damaging the impeller, blades, screws, etc. used in the pumps. Additionally, the pump may break the rigid particles into smaller pieces as they are pumped through the pump which may be undesirable. Moreover, the rigid particles are prone to clumping together as they travel along a channel which may cause the processing channel to become clogged or otherwise result in an undesirable flow profile.

In view of these and other issues, it may be desirable to have a system and method for dosing particles into a food processing stream in a manner which is more controllable, consistent, and decreases damage to the processing equipment.

### BRIEF DESCRIPTION OF THE DRAWINGS

FIG. 1 is a schematic diagram of a food processing system including a first processing line and a second processing line.

FIG. 2A is a schematic diagram of a holding section of the food processing system of FIG. 1.

FIG. 2B is a schematic diagram of a holding section of the food processing system of FIG. 1 according to another embodiment.

FIG. 3 is a schematic diagram of the second processing line of the food processing system of FIG. 1 including a rotary feeder system.

FIG. 4 is a front view of the second processing line of FIG. 3.

FIG. 5 is a flow diagram of a method for processing a food component according to one embodiment.

FIG. 6 is a flow diagram of a method for processing a food component according to another embodiment.

FIG. 7 is a flow diagram of a method for processing a food component according to another embodiment.

FIG. 8 is a flow diagram of a method for processing a food component according to another embodiment.

FIG. 9 is a cross-sectional view of one form of a mixer tank.

FIG. 10 is a top view of an interior of the mixer tank of FIG. 9.

FIG. 11 is a side view of one form of an inlet flow path to a rotary feeder.

FIG. 12 is a cross sectional view of a rotary feeder.

FIG. 13 is a side view of one form of a vane for the rotary feeder of FIG. 12.

### DETAILED DESCRIPTION

The present disclosure relates to systems, processing equipment, and methods for transporting and combining food materials, process fluids, and the like. The disclosure also relates to distribution of other solid particles, such as tags, indicators, and the like used to analyze the flow properties in the systems, equipment, and methods. As used herein, the term flow path generally refers to pipes, conduits, inlets, outlets, and other associated equipment used for transporting solids, fluids, and the like. It should be appreciated that the term fluid may include both liquids and gases. As used herein, the term process line generally refers to a group and/or series of processing operations, equipment and the like along one or more flow paths.

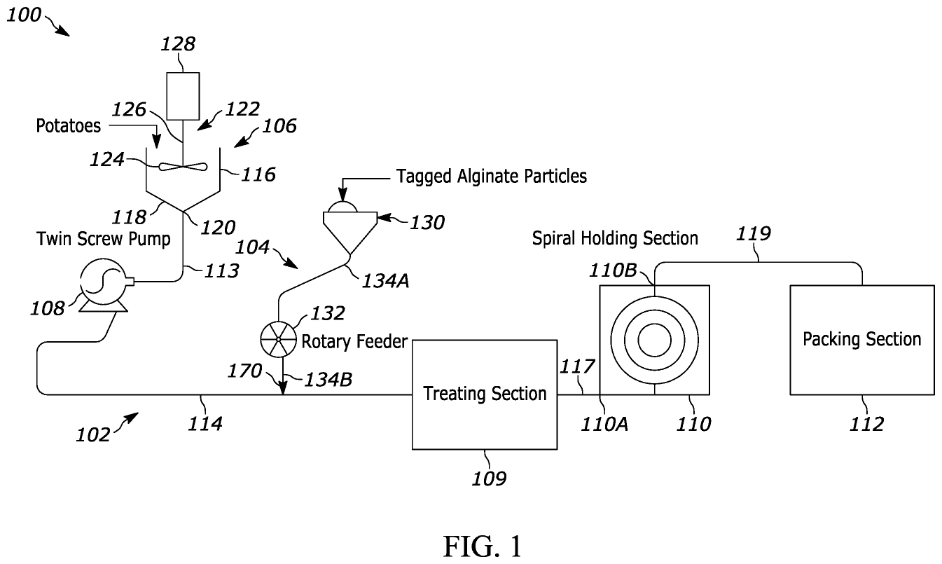

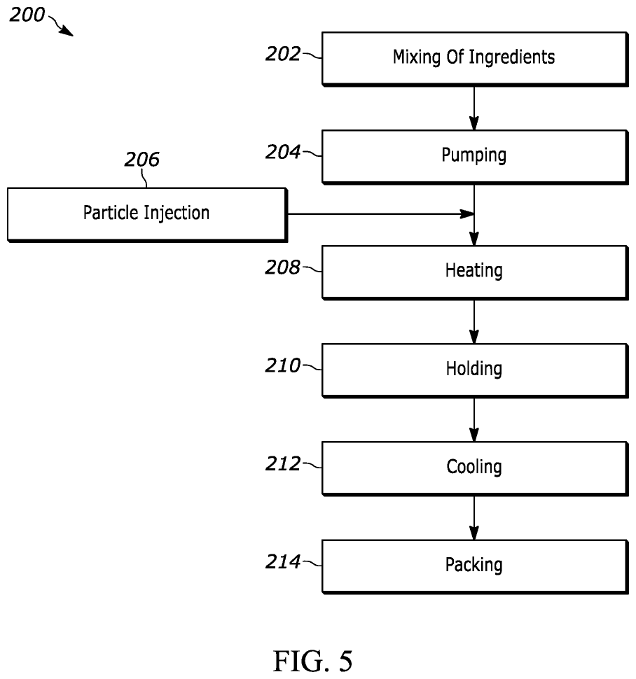

With reference to FIG. 1, a food processing system 100 is provided. The food processing system 100 includes a first process line 102 and a second process line 104. The first process line 102 includes a mixer tank 106, a pump 108, a treating section 109 (e.g., sterilization and/or heating section), a holding section 110, and a packing section 112. Various flow paths can be used to interconnect the components and to connect to additional flow paths. For instance, fluid channels or conduits extend between these elements such that one or more food components flow from the mixer tank 106, to the pump 108, to the treating section 109, to the holding section 110, and to the packing section 112. More specifically, the food components flow from the mixer tank 106 to the pump 108 along pipe 113, from the pump 108 to the treating section along pipe 114, from the treating section 109 to the holding section 110 along pipe 117, and from the holding section 110 to the packing section 112 along pipe 119. The pipes may be formed of food safe material that is readily cleanable. In other forms, the food processing system 100 may have other configurations, such as those discussed with respect to FIGS. 5-8 below.

The mixer tank 106 includes a container 116 for receiving a process fluid, such as a food component and/or relatively fine particles to be processed. As examples, the process fluid in the mixer tank may be a broth, sauce, water, starch slurry, oil, milk, cream, and the like. As an example, the particles received in the container 116 of the mixer tank 106 may have a maximum dimension (e.g., a diameter) in the range of 3 mm to 25 mm. The container 116 may include a lower portion 118 that has a funnel shape and/or tapers inward toward an outlet 120 connected to the pipe 113 to direct the mixture from the container 116 into the pipe 113. The mixer tank 106 may include an agitator or mixer 122 to mix the fluid and/or particles together that are received into the container 116. The mixer 122 may include mixer blades 124 coupled to a rotatable shaft 126. The mixer 122 may include a motor 128 that rotates the shaft to turn the mixer blades 124 to mix the fluid and/or particles together.

The mixture flows from the mixer tank 106 through the pipe 113 to the pump 108. The pump 108 may be, as examples, a twin screw pump, piston pump, rotary lobe pump, sinusoidal lobe pump, or other volumetric pump that is operable to control flow rate. The pump 108 may include an upstream end to draw the mixture from the mixer tank 106 and force the mixture to a downstream end along the first line 102 to be processed. For example, the pump 108 pumps the mixture along a flow path, such as pipe 114 toward the treating section 109. An outlet end 170 of the second process line 104, discussed in further detail below, is connected to the pipe 114 between the pump 108 and the treating section 109 to inject particles into the mixture stream flowing from the pump 108.

The treating section 109 may be a section of the processing system 100 where the mixture in the pipe is treated, for example, heat treatment, sterilization, and the like. For example, electromagnetic radiation, such as radio wave or microwave radiation, may be applied to the mixture in the pipe 114 of the treating section 109 to sterilize the mixture. As another example, heat may be applied to the mixture in the treating section 109 to sterilize the mixture. For instance, a hot fluid (e.g., liquid or gas) may contact and/or flow over the pipes 114 of the treating section 109 to indirectly heat the mixture within the pipes to sterilize the mixture in the pipes.

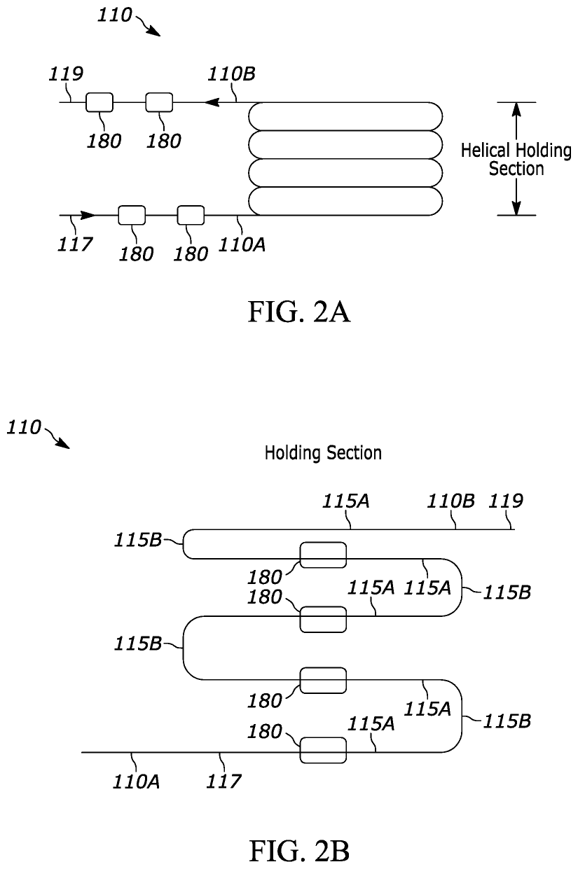

The mixture flows from the treating section 109 to the holding section 110 along pipe 117. The holding section 110 has an inlet 110A and an outlet 110B. The mixture (and particles from the second process line 104) flows into the holding section from the inlet 110A and may be held at a treatment temperature (e.g., a sterilizing temperature) until it reaches the outlet 110B to fully treat the mixture and/or particles. The pipe forming the holding section 110 between the inlet 110A and the outlet 110B may have a long length to increase the length of time the mixture is in the holding section 110 and being treated which is known as the residence time. For example, the length of the pipe forming the holding section 110 may be selected based on the flow rate of the mixture through the pipe so that the mixture is within the holding section 110 and held at the treatment temperature for a period of time long enough to fully treat the mixture. With respect to FIG. 2A, the pipe 117 of the holding section 110 may be wound helically into a coil to reduce the size or footprint of the holding section 110 portion of the food processing system 100. With respect to FIG. 2B, the pipe 117 of the holding section 110 is shown according to another configuration. As shown, the pipe 117 bas a plurality of straight sections 115A connected by U-shaped bends 115B such that the pipe 117 winds back and forth to increase the length of the flow path through the holding section 110 while keeping the holding section relatively compact (e.g., compared to a straight pipe of the same length).

The mixture and particles flows along the pipe 117 from the holding section 110 to the packing section 112. In the packing section 112, the mixture and/or particles may be dispensed into packaging for storage and/or distribution.

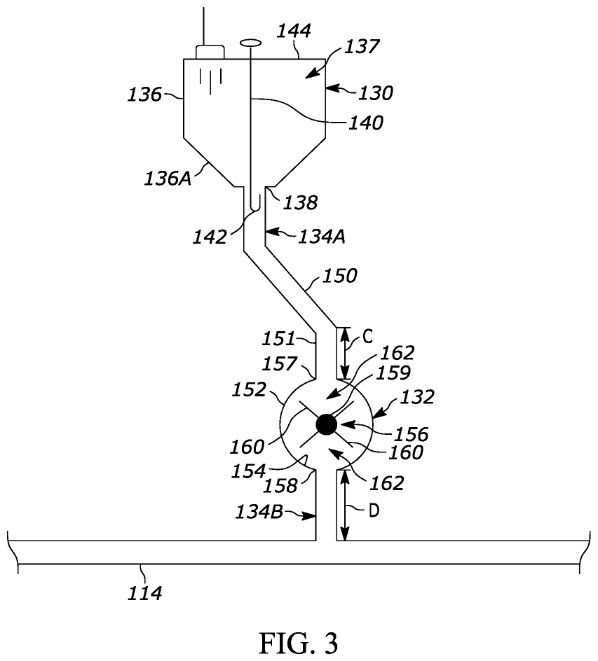

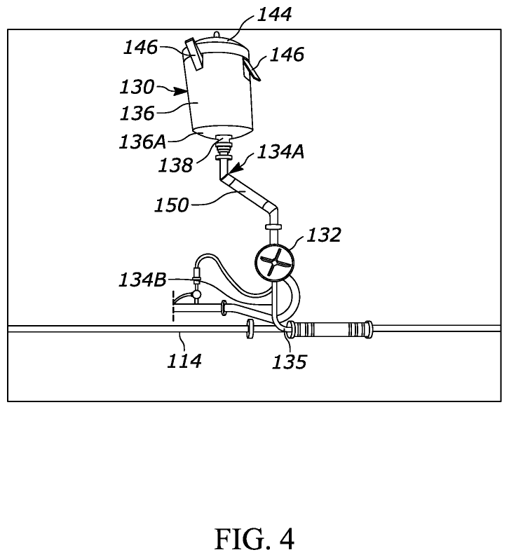

With respect to FIGS. 3-4, a schematic and perspective view, respectively, of the second process line 104 is provided. The second process line 104 includes a particle feed source such as hopper 130 and a rotary feeder 132. A rotary feeder may provide for various advantages for incorporating particles into different flow paths. A rotary feeder, especially as used with the pipe configurations described herein, may permit particles to be more uniformly distributed.

Further, the rotary feeder can be configured to decrease deformation/crushing of the particles, as will be understood from the below further discussion. Further, the rotary feeder may provide for less disturbance in the flow of other process streams as could occur when splitting and/or rejoining streams. Other advantages also permit for increased amounts of particles that can be distributed as less clogging can occur.

A flow path, such as pipe 134A, extends from the hopper 130 to the rotary feeder 132. A flow path, such as pipe 134B, extends from the rotary feeder 132 to connect to the pipe 114 of the first process line 102 downstream of the pump 108 and upstream of the holding section 110. Connecting the pipe 134B downstream of the pump 108 may be beneficial to avoid passing solid particles through the pump 108. In other embodiments, however, the pipe 134B may be connected at another location of the food processing system 100. For example, the pipe 134B may connect to the first process line 102 upstream of the pump 108 or downstream of the holding section 110. For instance, the pipe 134B may be arranged to deposit the solid particles into the mixer tank 106 upstream of the pump 108.

The hopper 130 has walls 136 forming a cavity 137 for receiving the particles. The lower portion 136A of the walls 136 form a funnel or taper inward toward an outlet 138 connected to the pipe 134A. Particles received in the hopper 130 are thus directed toward the outlet 138 by gravity and the tapered lower portion 136A of the hopper 130. The particles in the hopper may be rigid and/or semi-rigid. The particles may be chunks of food, including, as examples, potatoes, carrots, beans, broccoli, cauliflower, beef, chicken, and the like. The particles may also, and/or alternatively, include test particles. For example, alginate particles having RFID or other trackable components may be used, as described in further detail below.

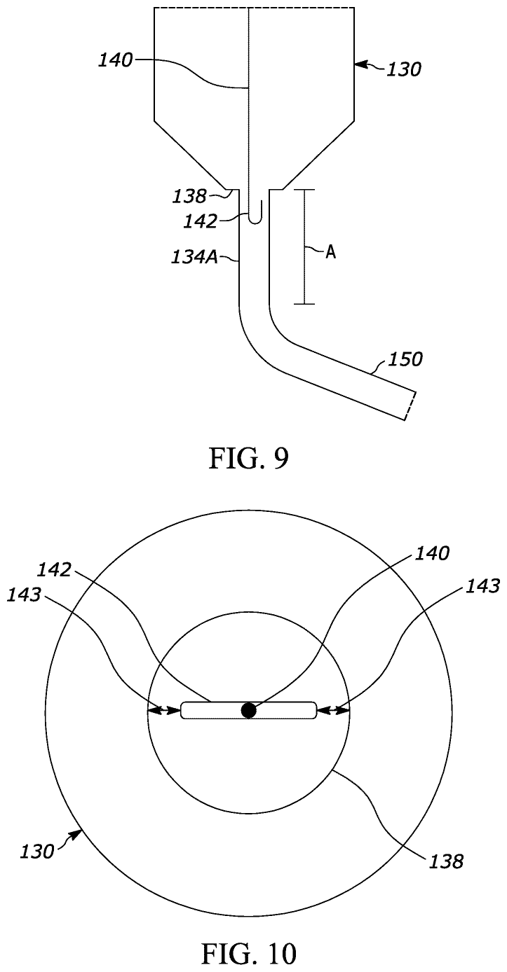

The hopper 130 may include a stir rod 140 that may be used to stir or move the particles in the hopper 130, for example, to unclog the particles in the hopper 130 and/or break up particle bridging so that the particles flow through the outlet 138 and into the pipe 134. In one embodiment, the stir rod 140 includes a hook 142 at an end portion thereof to aid in moving the particles. For example, the stir rod 140 may extend substantially vertically into the hopper 130 and be rotatable such that the hook 142 swivels about an axis to contact and move the particles. In some forms, such as shown in FIG. 9, the hook 142 is just slightly smaller than an inside diameter of the outlet 138 and pipe 134A. It should be appreciated that other shapes besides hooks may be used on the stir rod 140. For example, the stir rod may have a paddle, flange, or other shape to help move particles.

In some embodiments, the hopper 130 has a lid 144 that is removably attachable to a body of the hopper 130. The lid 144 may be removed to fill the cavity 137 of the hopper 130 with the particles. When attached to the hopper 130, the lid 144 may form fluid tight seal with the walls 136 of the hopper 130. The lid 144 allows the hopper 130 to be pressurized to inhibit the mixture flowing through the first process line 102 from flowing upward through the second process line 104 and, for example, overflowing out of the hopper 130. A rubber gasket may be positioned between the lid and the hopper 130 to form a fluid tight seal. Moreover, the lid 144 may be clamped to the hopper 130 with clamps 146 (see FIG. 4) to secure the lid 144 to the hopper 130 and to maintain the fluid tight seal therebetween. In some embodiments, the hopper 130 may be pressurized, for example, by applying compressed air in the hopper 130 to increase the pressure of the hopper 130 and to provide sufficient back pressure to inhibit the mixture of the first process line 102 from flowing up the second process line 104 and to permit the particles dispensed from the rotary feeder 132 to enter the pipe 114 of the first process line 102. The second process line 104 may be pressurized such that the hopper 130, rotary feeder 132, and/or pipes 134A, 134B have a pressure equal to or exceeding the pressure of the first flow line 102. In some forms this pressure may be about 0.5 bar, 1.0 bar, 1.5 bar, 2.0 bar, 2.5 bar, 3.0 bar, 3.5 bar, or more. The hopper 130 and/or lid 144 may include a pressure reducer valve to adjust the pressure of the hopper 130 and or a safety valve in case of pressure build up in the food processing system 100.

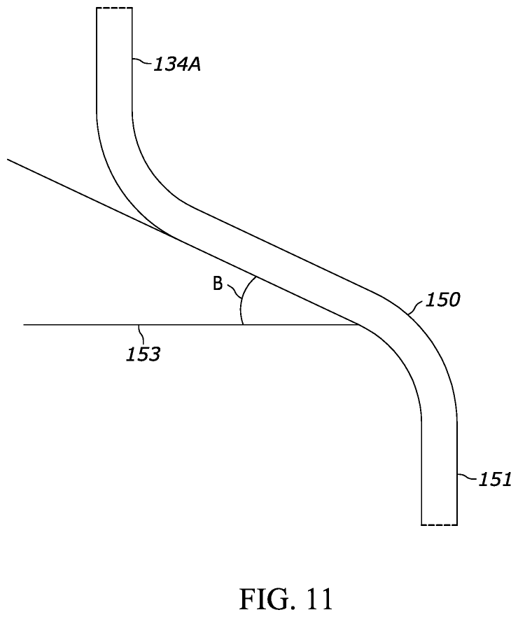

Pipe 134A extends from the outlet 138 of the hopper 130 to an inlet 157 of the rotary feeder 132. The pipe 134A may extend vertically such that the particles flowing into the pipe 134A are drawn along the pipe 134A toward the hopper 130 by gravity. The pipe 134A may include a sloped portion 150 that extends horizontally an oblique angle relative to the horizontal. Including the sloped portion 150 on the pipe 134A may aid to control the flow of the particles as they pass through the pipe 134A to the rotary feeder 132 by inhibiting the particles from free falling which often results in clogging the pipe 134A while providing enough of a slope to permit the particles to be drawn through the pipe 134A by gravity. One exemplary form is shown in FIG. 11 as represented by angle B relative to a horizontal line 153. For example, the sloped portion 150 may extend at an angle in the range of about a 15° to about a 60° angle relative to the horizontal. In some forms, the angle is about 20° to about 40° and in some forms the angle is about 25° to about 35° relative to the horizontal axis.

In some forms, the pipe 134A is generally positioned in a substantially vertical orientation, as shown in FIG. 9. Further, the pipe 134A has a length A before sloped portion 150. This length A can help provide for a slight drop for the particles enter the sloped portion 150 to permit a desired momentum for the particles. In some forms, length A is about 5 to about 25 cm. In other forms, the length A is about 10 to about 18 cm.

Similarly, other portions of the flow paths may be oriented in substantially vertical or other orientations. In one form, as shown in FIG. 3, pipe 151 and pipe 134B may be configured in a substantially vertical orientation. Further, pipe 151 may have a substantially vertical length C and pipe 134B may have a substantially vertical length D. Lengths C and D can be chosen to provide the desired drop distance before entering the rotary feeder 132 and the end portion 135 and/or pipe 114. In some forms, the length C is about 5 to about 20 cm. In other forms, this distance is about 10 to about 15 cm. In some forms, the length D is about 15 to about 30 cm. In other forms, this distance is about 20 to about 25 cm.

In some forms, as shown in FIG. 10, an end of the stir rod 140, such as hook 142, is positioned a distance from an inside diameter of the outlet 138 and/or pipe 134A. This distance, as shown by reference 143 in FIG. 10. The distance can be selected to provide suitable spacing and also decrease damage to the particles while also permitting, the particles to pass through the outlet 138 and pipe 134A. In some forms, this distance is about 1 to about 8 cm. In other forms, this distance is about 2 to about 5 cm.

The particles flow through the pipe 134A to the rotary feeder 132. The rotary feeder 132 includes a housing 152 having the inlet 157 and an outlet 158. The housing 152 includes a substantially cylindrical internal surface 154. The rotary feeder 132 further includes a rotor 156 having a hub 159 with a plurality of vanes 160 extending radially from the hub 159 to the internal surface 154. The vanes 160 may be formed of a flexible material (e.g., a rubber) to inhibit the vanes 160 from crushing, breaking, or otherwise deforming the particles. In some forms, the radially outer portion or tips 161 of the vanes 160 are formed of a flexible rubber while the radially inner portion 163 of the vanes are formed of a rigid material. The rotor 156 includes a pocket 162 between adjacent vanes 160. The rotor 156 is rotatable within the housing 152 such that the pockets 162 are rotated by the inlet 157 and outlet 158 of the housing 152. As a pocket 162 passes the inlet 157 of the housing 152, particles from the pipe 134 fall into the pocket 162. As the rotor 156 is rotated, the vanes 160 form a closed cavity with the internal surface 154 until the pocket 162 aligns with the outlet 158 at which point the particles fall out of the pocket 162 and into the pipe 134B. In some forms, the vanes 160 extend to the internal surface 154 to form a sealed cavity when the pocket 162 is not aligned with the inlet 157 or outlet 158.

The rotary feeder 132 may include end walls at the ends of the housing 152 that close the axial ends of the cylindrical internal surface 154. A gasket may be positioned between the end walls and the housing 152 to form a fluid tight connection therebetween. The axial ends of the rotor 156 may contact the end walls of the rotary feeder 132 such that the end walls define the pockets 162 of the rotor 156. For example, the vanes 160 of the rotor 156 extend axially from one end wall to the opposite end wall. In some forms, one or more of the end walls of the rotary feeder 132 are formed of a transparent material (e.g., acrylic) so that the pockets 162 are visible from outside of the rotary feeder 132, for example, to permit an operator to monitor the operation of the rotary feeder 132.

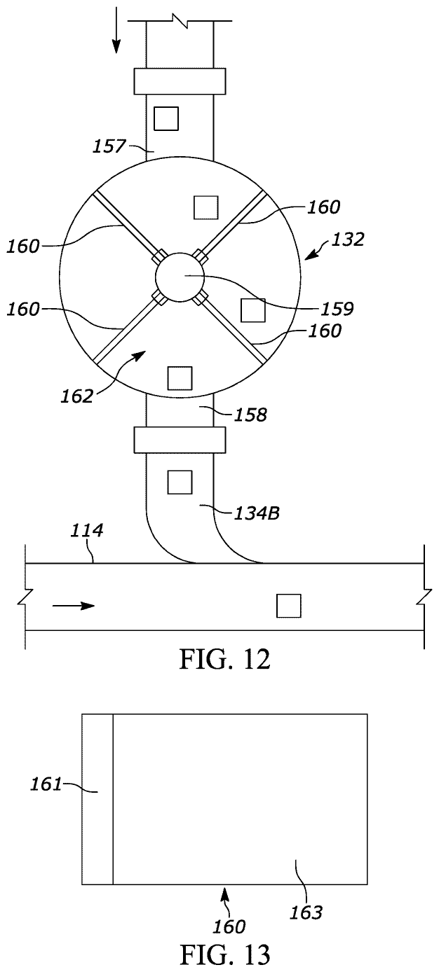

The particles flow through the pipe 134B and into the pipe 114 of the first process line 102 whereby the pipes merge, such as shown in FIG. 12. The rotary feeder 132 is thus able to control the flow of particles from the hopper 130 and into the first process line 102. Through testing, discussed in further detail below, the rotary feeder 132 has been found to dispense the particles from the hopper 130 with significantly less clogging of the particles in the pipes as compared to prior approaches allowing the particles to be dispensed consistently and uniformly into the mixture of the first process line 102. For instance, the rotor 156 may be rotated at a speed to dispense the desired amount of particles into mixture of the first process line 102. The speed of the rotor 156 may be selected based on the flow rate of the mixture and the desired amount of particles per unit volume of the fluid to uniformly dispense the particles into the mixture. In some forms, a motor (e.g., an AC or DC motor) is connected to the rotor 156 to turn the rotor 156 within the housing 152 of the rotary feeder 132 to dispense the particles.

The end portion 135 of the pipe 1346 of the second process line 104 connecting to the pipe 114 of the first process line 102 may be curved (see FIG. 4) to direct the particles to flow in the direction of the mixture through the pipe 114 of the first process line 102. Having the end portion 135 of the pipe 1346 curved may also aid to inhibit the mixture of the first process line 102 from flowing upward through the pipe 134B. A vacuum pump may also be installed downstream of the rotary feeder 132 to aid particles dispensed from the rotary feeder 132 to enter the mixture flowing through the pipe 114. For example, the vacuum pump may be operated to reduce the pressure downstream of the rotary feeder 132, for example, on pipe 134B or anywhere along the first process line 102 downstream of the second flow line 104 (e.g., before the treatment section 109, holding section 110, and/or packing section 112). Installing the vacuum pump along the first process line 102 downstream of the second flow line 104 may aid in reducing the flow of mixture up the pipe 134B which aids the particles in traveling along the pipe 134B to enter the mixture in the pipe 114. The mixture and the particles then flow through the holding section 110 and to the packing section 112 of the first process line 102 as described above.

As mentioned above, use of the second process line 104 including the rotary feeder 132 to dispense solid particles to the mixture of the first process line 102 has been found to address problems with prior approaches. More specifically, the second process line 104 is able to dispense the solid particles in a controlled manner such that the solid particles are sufficiently spaced from one another when added to the mixture in the first process line 102 with mitigates clogging of the solid particles in the pipe 114. Controlling the distribution of the particles in the mixture also permits the ratio of the solid particles to the mixture to be controlled as desired (e.g., a ratio of potatoes to broth). Uniformly distributing the solid particles into the mixture permits the solid particles to be carried by the mixture through the holding section 110 for a desired period of time, for example, such that the particles are not over treated or under treated.

The effectiveness of the food processing system 100 was validated experimentally. For example, experiments were conducted to analyze the residence times of the solid particles in the holding section 110. For example, experiments were conducted to analyze the average particle residence time and minimum particle residence time. To measure the position of the solid particles as they traveled through the food processing system 100, solid particles were formed of an alginate material with an embedded RFID tag or transponder. RFID readers 180 were positioned at various points along the pipe 114 of the food processing system 100. With reference to FIG. 2A, for example, the RFID readers 180 were mounted at the inlet 110A and outlet 110B of the holding section 110 to monitor the period of time the alginate particle was in the holding section 110 which corresponds to residence time particles are treated at the holding section 110. With reference to FIG. 2B, the RFID readers 180 may also be mounted at various portions of the pipe 114 internal to the holding section 110. The RFID readers 180 may continuously transmit radio frequency waves which activate the RFID tags of the alginate particles as they pass the RFID reader 180 which causes the RFID tag to send a signal back to the RFID reader 180 identifying the RFID tag, The RFID reader 180 may include a signal generator which sends the RF signal to the RFID tags, a receiver to receive the feedback signal from the RFID tags, and a microcontroller to process the information. The RFID tag may be an active, passive, or semi-passive RFID tag. Where the RFID tags are passive RFID tags, the RFID tags may include a transponder which receives and sends signals to the RFID readers 180 and a rectifier circuit which uses the radio waves from the RFID reader 180 to store energy in a capacitor and to power a controller and a memory unit of the RFID tag.

The RFID readers 180 are connected to a computer that collects and stores the data collected by the RFID readers 180 pertaining to the RFID tags. For instance, the RFID readers 180 transmit an identifier received from the RFID tags (e.g., a serial number of the RFID tag) passing the RFID reader 180 and/or a time at which the signal was received from the RFID tag. The RFID readers 180 were thus used to track the alginate particles as they traveled through the food processing system 100, for example, to determine the spacing between the alginate particles and/or the time it takes for each alginate particle to travel between two RFID readers 180. For instance, the RFID readers 180 were used to determine the period of time each alginate particle was in the holding section 110 to determine whether the alginate particle resided in the holding section for a minimum period of time to properly treat (e.g., sterilize) the particles. Additionally, through such testing, it was determined that use of the rotary feeder 132 to dispense solid particles into the mixture stream flowing through the pipe 114 of the first process line 102 was advantageous over prior systems. For instance, due to the degree of control over the solid particles being dispensed into the pipe 114 with the rotary feeder 132, the solid particles were able to be spaced apart from one another uniformly. As a result, it was found that using the rotary feeder 132 a greater number of solid particles are able to be dispensed into the first process line 102 without clogging the pipe 114 as the particles traveled therethrough.

With respect to FIG. 5, a process 200 is provided for processing a food component, for example, with the food processing system 100 described above. Ingredients for the food component are mixed 202 together to form a pumpable or flowable mixture. For example, a fluid and fine particles may be mixed together to form the mixture. For example, the ingredients may be added into the container 116 of the mixer tank 106 and mixed together with the mixer 122. The mixture is pumped 204 by the pump 108 from the mixer tank 106 along a flow path, such as pipe 114. Solid particles are injected 206 into the mixture pumped from the mixer tank 106 along the pipe 114 to introduce solid particles into the mixture to form the food component. For example, the rotary feeder 132 may be operated to dispense a controlled amount of solid particles into the mixture as discussed above. Heat is applied 208 to the food component to treat the particles and/or mixture. For example, the heat may be applied to cook and/or sterilize the food component. Heat may be applied to the food component by applying microwave radiation to the food component within the pipe 114 and/or the holding section 110. Once heated, the food component is held 210 at a temperature high enough to treat the food component and long enough to fully treat the food component. For example, the food component is held at the treating temperature as it flows through the holding section 110 of the food processing system 100. Radio frequency treatment may also be used to treat the particles and/or mixture at one or more points in the overall process. The food component is then cooled 212 and packed 214 (e.g., in packaging) for storage and/or distribution.

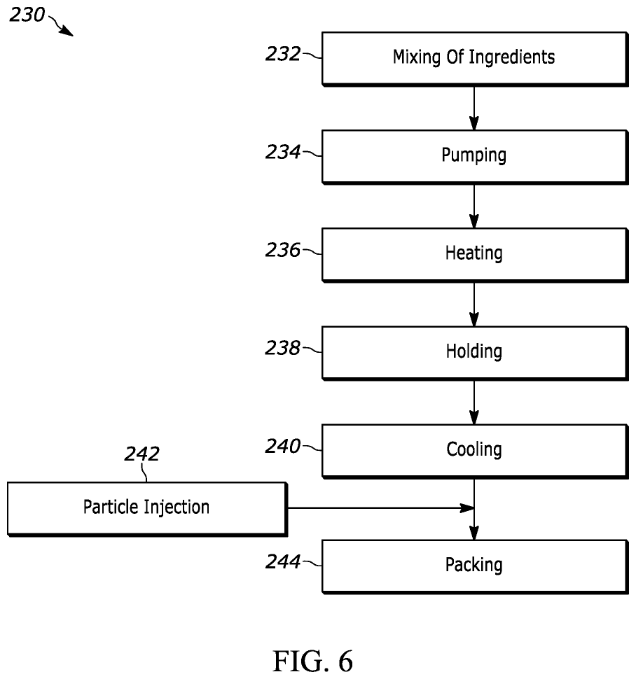

With respect to FIG. 6, another process 230 is provided for processing a food component that is similar to the process 200 discussed above such that the differences will be highlighted. In process 230, the steps of mixing 232 the ingredients to form the mixture and pumping 234 the mixture are similar to the corresponding steps of process 200. In process 230, however, the solid particles are not added to the mixture before the heating step. Instead, the steps of heating 236, holding 238, and cooling 240 may be performed on the mixture without the solid particles similar to the corresponding steps discussed above. Once the mixture has cooled, the solid particles are injected 242 into the mixture and packaged 244 for storage and/or distribution. For example, as the mixture is pumped along a pipe after cooling, the solid particles are added into the mixture flowing through the pipe as discussed above with respect to the food processing system 100. For instance, the rotary feeder 132 may be operated to dispense the particles into the cooled mixture. This process 230 may be performed when the particles are separately treated from the mixture, for example, where the particles are pre-sterilized or do not need sterilization, As another example, the process 230 may be performed where the particles need to be treated differently than the mixture such as at a higher temperature and/or the particles are not able to withstand the heating 236 and/or holding 238 steps.

While the above processes 200, 230 disclose specific examples where the particles are injected before the step or heating or after the step of cooling, in other embodiments the particles may be injected at any point between the pumping and packing steps.

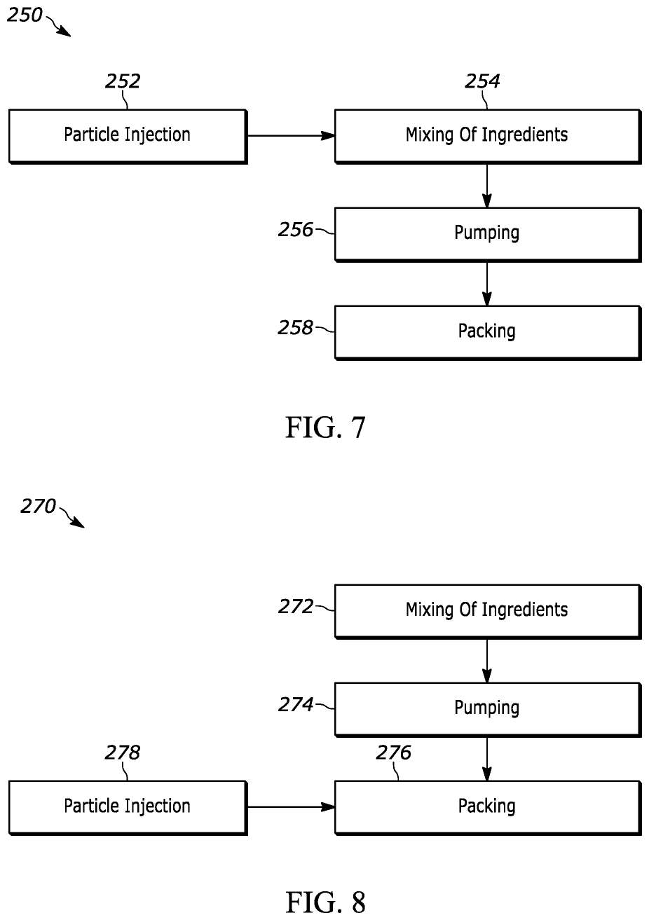

With respect to FIG. 7, a process 250 is provided for processing a food component according to another embodiment. The process 250 may be similar in many respects to the processes discussed above with the primary difference being that the particles are injected 252 with the other ingredients of the food component and mixed 254 together with the other ingredients. For example, the particles may be dispensed into the mixer tank 106 and mixed in with the other ingredients by the mixer 122. One or more rotary feeders 132 may be used to dose a controlled amount of the particles into the mixer tank 106 with other ingredients of the food component. In this embodiment, the particles may be fine enough to pass through the pump 108 without causing damage to the pump and/or the particles. The mixture may be pumped 256 from the mixer tank 106 to be packaged 258. In some embodiments, the steps of heating, holding, and/or cooling discussed above may also be applied to the mixture before the step of packaging 258.

With respect to FIG. 8, a process 270 is provided for processing a food component according to yet another embodiment. The process 270 is similar to the processes discussed above with the primary difference being that the particles are added to the mixture in the packing step. Ingredients of the food component may be mixed 272 together to form a mixture and pumped 274 along a flow path (e.g., a pipe) as discussed above. In some embodiments, the steps of heating, holding, and/or cooling may be applied to the mixture as the mixture is pumped along the flow path. The mixture may then be packaged 276 along with the solid particles. For example, the mixture may be dispensed into a package for storage or distribution. The solid particles may also be injected 278 into the packaging to add the solid particles to the mixture to form the food component. For instance, the rotary feeder 132 may be operated to dispense a controlled amount of the particles into each package. In some forms, the solid particles are dispensed into the package before the mixture is added into a package. In some forms, the solid particles are dispensed into the package after the mixture is added to the package. In some forms, the solid particles are dispensed into the package concurrently with the mixture.

While the above processes describe injecting the solid particles into the mixture at various points along the food processing system, these processes may be combined. For example, rotary feeders 132 may be used to inject solid particles at multiple points along the food processing system. For instance, the food component may include two or more different types of solid particles that are injected at different points of the process. For example, one type of solid particle may need to be sterilized and be added before the heat and holding step while another solid particle is pre-sterilized and added to the mixture after the heat and holding steps. Those having skill in the art will recognize the wide variety of modifications that can be made using the above processes to inject solid particles at one or more points along a food processing line, for example, using one or more rotary feeders 132 discussed above.

Uses of singular terms such as “a,” “an,” are intended to cover both the singular and the plural, unless otherwise indicated herein or clearly contradicted by context. The terms “comprising,” “having” “including” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A food processing system comprising:
a pump configured to flow a food component from an upstream end to a downstream end of the pump;
a first flow path operably coupled to the downstream end of the pump; and
a rotary feeder having an inlet end, a rotor, an outlet end, the inlet end operably coupled to a particulate feed source via a second flow path, the outlet end operably coupled to the first flow path via a third flow path, and the rotor having at least one pocket configured to receive at least one solid particle from the second flow path, the rotor being rotatable to transfer the at least one solid particle from the at least one pocket to the first flow path via the third flow path.

2. The food processing system of claim 1 wherein the rotor of the rotary feeder has a plurality of vanes, the at least one pocket formed between two vanes of the plurality of vanes.

3. The food processing system of claim 2 wherein the plurality of vanes include a first portion extending from a central axis and a second portion extending from the first portion, the second portion being more flexible than the first portion.

4. The food processing system of claim 1 wherein the third flow path is pressurized and has a pressure equal to or exceeding the pressure of the first flow path.

5. The food processing system of claim 4 wherein a pressure of the third flow path and/or the second flow path exceeds a pressure of the first flow path by about 0.5-2.0 bar.

6. The food processing system of claim 1 wherein the second flow path includes a sloped portion that extends an oblique angle relative to a horizontal axis at an angle of about 15-60 degrees relative to the horizontal axis.

7. The food processing system of claim 1 wherein an end portion of the third flow path is curved to guide the at least one solid particle from the third flow path into the first flow path in a downstream direction.

8. A food processing system comprising:
a first flow path configured to direct a first fluid;
a particulate feed source configured to contain and dispense a plurality of solid particles;
a rotary feeder having an inlet and an outlet;
a second flow path extending from the particulate feed source to direct a second fluid and at least one of the plurality of solid particles to the inlet of the rotary feeder, at least a portion of the second flow path extending at an angle of about 15-60 degrees relative to a horizontal axis; and
a third flow path extending from an outlet of the rotary feeder to the first flow path, a pressure of the third flow path exceeding a pressure of the first flow path by at least about 0.2-2.0 bar.

9. The food processing system of claim & wherein a rotor of the rotary feeder has a plurality of vanes with at least one pocket formed between two vanes of the plurality of vanes.

10. The food processing system of claim 9 wherein the plurality of vanes include a first portion extending from a central axis and a second portion extending from the first portion, the second portion being more flexible than the first portion.

11. The food processing system of claim 8 wherein a pressure of the third flow path and/or the second flow path exceeds a pressure of the first flow path by about 0.5-1.5 bar.

12. The food processing system of claim 8 wherein the second flow path further includes a substantially vertical portion.

13. The food processing system of claim 8 wherein the sloped portion of the second flow path extends at an angle of about 20-50 degrees relative to the horizontal axis.

14. The food processing system of claim 8 wherein an end portion of the third flow path is curved to guide the at least one solid particle from the third flow path into the first flow path in a downstream direction.

15. The food processing system of claim 8 further comprising a stirrer positioned in at least one of the particulate feed source and the second flow path.

16. The food processing system of claim 15 wherein the stirrer is configured to perform at least one motion selected from rotating and moving axially.

17. A method comprising:
pumping a food component along a first flow path; and
rotating a rotor of a rotary feeder to dispense solid particles into the food component pumped through the first flow path, the rotary feeder having an inlet connected to a second flow path extending from a particulate feed source and an outlet connected to a third flow path that connects to the first flow path.

18. The method of claim 17 further comprising pressurizing at least the third flow path to inhibit the food component from flowing from the first flow path toward the rotary feeder along the third flow path.

19. The method of claim 17 further comprising measuring a flow rate of the food component along the first flow path and wherein rotating the rotor includes rotating the rotor at a speed based at least on part on the flow rate.

20. The method of claim 19 wherein the speed of the rotor is selected to add a specified amount of solid particles per unit volume of the food component of the first flow path.

21. The method of claim 17 wherein the rotor includes at least one pocket rotatable to transport solid particles from the second flow path to the third flow path.
